(19) United States
(12) Patent Application Publication
(10) Pub. No.: US 2016/0111692 A1
(43) Pub. Date: Apr. 21, 2016

(54) POWER SUPPLY DEVICE

(71) Applicant: SANYO ELECTRIC CO., LTD., Osaka (JP)

(72) Inventors: HIDEYO MORITA, Hyogo (JP); KOICHI INOUE, Hyogo (JP); HIROSHI NAGAMINE, Osaka (JP); HIROKI KATO, Hyogo (JP)

(21) Appl. No.: 14/890,137

(22) PCT Filed: Sep. 8, 2014
(86) PCT No.: PCT/JP2014/004593

§ 371 Date: Nov. 9, 2015

(30) Foreign Application Priority Data
Oct. 29, 2013 (JP) 2013-223943
Apr. 4, 2014 (JP) 2014-077961

(51) Int. Cl. H01M 2/10; H01M 10/623; H01M 10/6554; H01M 10/613; H01M 10/6551

(52) U.S. Cl. CPC H01M 2/1061; H01M 10/613; H01M 10/6551; H01M 10/6554; H01M 10/623; H01M 2220/30

(57) ABSTRACT

The first case has an outer surface extending portion at which the end edge side of the first case extends toward the second case side at an outer surface side of the main body case, and also has an inner surface extending portion at which the end edge side of the first case extends along an inner surface of the second case, and the outer surface extending portion and the inner surface extending portion of the first case sandwich the step-shaped projection of the second case in a state where the first case and the second case are joined, and upper end edges of the holder side walls support a lower end edge of the inner surface extending portion by contacting.

### TECHNICAL FIELD

The present invention is related to a power supply device incorporating a rechargeable secondary battery in an outer case, especially a portable power supply device connectable outside to electric equipment for supplying power.

### BACKGROUND ART

In accordance with portable electric devices, portable power supply devices called an auxiliary power supply device or a booster have been developed and supplied. Such portable power supply devices incorporate a secondary battery, and the incorporated secondary battery is charged with supplied power, and the secondary battery is discharged to supply power to external electric devices.

As such a portable power supply device, a power supply device which incorporates a pair of cylindrical batteries, has been developed (refer to patent literature 1). As shown in an exploded perspective view of FIG. 25, this power supply device is used as a portable power supply device for the electric device, and an insulating holder 203 is disposed between the pair of the cylindrical batteries 201, and by this insulating holder 203, the cylindrical batteries 201 and a circuit board 204 are disposed in fixed positions to prepare a battery core 209, and then this battery core 209 is stored in an outer case 202.

As this portable power supply device is used to charge the portable electric device such as a mobile phone or a smart phone when users go out, weight reduction or thinning of it is required to easily carry it. In contrast, it is required to incorporate a large capacity of the secondary battery in order to use more power. In place of the cylindrical battery, a portable power supply device which incorporates a prismatic battery, in other words, a rectangular parallelepiped battery having an excellent space efficiency, have been developed.

Under this circumstance, in order that the large capacity of the secondary battery is efficiently disposed in a limited space and also the outer size of the portable power supply device is made compact, it is necessary to make a case thin. However, mechanical strength is decreased when thickness of the case is made thin. Especially, when the portable power supply device is carried, it is thought that impact force by dropping or a collision with others is added from outside. Then, appropriate strength is required.

For example, the following impact test is carried out. A cylindrical bar of φ (diameter) 16 mm is disposed on the portable power supply device, and a weight of 9.1 kgf is dropped from a height of 610 mm on the cylindrical bar. The impact force in this case is 89.2 N (9.1 kgf)×0.61 m=54.4 J. In order to correspond to this impact of about 55 J, the thickness of 3 mm or more is necessary when the case is made of polycarbonate resin.

However, generally, the case is made of a resin having an excellent insulation property. When the thickness of the resin case is large, there is a problem generating the sink of a resin when hardening a resin. For example, the thickness of 3 mm or more causes the sink of the resin in the case of polycarbonate resin.

A conventional portable power supply device disclosed in patent literature 2 contains a box-shaped outer case which is configured by two of dish-shaped case members, and secondary batteries stored in the space inside an outer case. In one of the two case members, an inner rib is formed in parallel to its side wall in spaced relationship with its side wall, and in the other of the two case members, the end edge of its wall is fitted between the side wall of the one of the two case members and the inner rib.

In the conventional portable power supply device, as the end edge of the other case member is fitted between the side wall of and the inner rib, it does not have enough strength against the impact force from outside.

### CITATION LIST

### Patent Literature

Patent Literature 1: Japanese Laid-Open Patent Publication No. 2009-131089

Patent Literature 2: Japanese Laid-Open Patent Publication No. 2010-153214

### SUMMARY OF THE INVENTION

The present disclosure is developed for the purpose of solving such drawbacks. One non-limiting and explanatory embodiment provides a portable power supply device which has an enhanced hardness without making a case thick.

A power supply device of the present disclosure connectable to electric equipment for supplying power comprises a main body case divided into a first case and a second case, and having an extending shape in one direction, a secondary battery incorporated in the main body case, and a battery holder for holding the secondary battery, and the second case has a box shape having a bottom portion, and a pair of case side walls in a longitudinal direction, and the battery holder has a pair of holder side walls to hold both sides of the secondary battery, and the holder side walls are formed so as to extend upward along at least a part of the case side walls from the bottom portion of the second case in a state where the battery holder is stored in the main body case, and the holder side walls are lower than the case side walls in height, and end edges where side walls of the first case and the side walls of the second case are joined, have step shapes in a vertical sectional view perpendicular to the longitudinal direction, and the second case has a step-shaped projection at an end edge side of the second case, the projection extending toward the first case side at an inner surface side of the main body case, and the first case has an outer surface extending portion at an end edge side of the first case, the outer surface extending portion extending toward the second case side at an outer surface side of the main body case, and an inner surface extending portion at the end edge side of the first case, the inner surface extending portion extending along an inner surface of the second case, and the outer surface extending portion and the inner surface extending portion of the first case sandwich the step-shaped projection of the second case in a state where the first case and the second case are joined, and wherein upper end edges of the holder side walls are in contact with and support a lower end edge of the inner surface extending portion.

In the power supply device of the present disclosure, a thickness of the main outer case is 1 mm to 3 mm.

In the power supply device of the present disclosure, the battery holder has a coil storing portion to store a power reception coil for non-contact charging. Accordingly, the secondary battery of the power supply device is charged by non-contact with power from the outside. Thus, the member storing the power reception coil can reinforce the side walls of the main body case. Then, the member is used for several purposes, and the structure can be simplified, and cost is reduced

The power supply device of the present disclosure further comprises a covering portion having flexibility for covering the first case, and the covering portion has a cover projecting portion which projects inward approximately in parallel with and in spaced relationship with a main surface thereof, and the first case has a fitting groove in the side walls for receiving the cover projecting portion. Accordingly, by covering the surface of the main body case with the covering portion having flexibility, in a case where external force is applied or added to the surface, stress is relaxed, and then members stored inside are protected. Further, the surface of the main body case or the electric equipment close to or mounted on this is prevented from being damaged. The cover projecting portion is fitted into the fitting groove, and then the covering portion is prevented from abruptly coming off.

In the power supply device of the present disclosure, the first case includes a partially recessed finger catching portion formed in a surface at an approximate center of a short direction perpendicular to the longitudinal direction at the boundary adjacent to the covering portion. Accordingly, as a user hooks a finger at the finger catching portion at changing the covering portions, the covering portion is easily detached and changed. Especially, tensile strength of the covering portion is weak around the center in the longitudinal direction, and then the covering portion easily comes off. When the finger catching portion is provided at this location, the covering portion more easily comes off. As the finger catching portion is provided in the short direction, it is prevented to easily come off.

In the power supply device of the present disclosure, a switch portion is provided at a location decentered from a center in the longitudinal direction. Accordingly, the switch portion can be disposed at a location where the switch portion contacts the secondary battery.

In the power supply device of the present disclosure, the covering portion has a cover side switch mark which indicates that the switch portion exists thereunder at a location corresponding to the switch portion in a state where the covering portion covers the first case. Accordingly, even though the covering portion covers the first case, a user can confirm by sight the location of the switch portion by using the cover side switch mark, and then the user can operate the switch portion through the covering portion.

The power supply device of the present disclosure further comprises a label portion stuck on an upper surface of the first case so as to cover the switch portion, and the label portion has a label side switch mark which indicates that the switch portion exists thereunder at a location corresponding to the switch portion. Accordingly, a user can confirm by sight the location of the switch portion by using the label side switch mark, and then the user can operate the switch through the label. Especially, the location of the switch portion can be confirmed by sight even in a state where the covering portion is detached, and then the portable power supply device can be used even without the covering portion. As the label side switch mark is also printed on the label where specification or the like is described, a number of parts is decreased, and manufacturing cost can be reduced.

In the power supply device of the present disclosure, the label side switch mark of the label portion is formed by embossing.

In the power supply device of the present disclosure, the covering portion has a positioning projection at a location which is not symmetrical with respect to the center in the longitudinal direction on an inner surface of the cover projecting portion, and the first case has a positioning recess portion formed to engage with the positioning projection at a location corresponding to the positioning projection. Accordingly, the positioning projection is engaged with the positioning recess portion, and then the fitting state of the covering portion and the first case can be strengthened. In addition, as the covering portion is not symmetrical, it prevents the covering portion from being set in the reverse posture. Especially, when the switch portion is provided at the location which is not symmetrical in the longitudinal direction, the covering portion can be set in the proper covering posture, and then it is prevented that the locations of the cover side switch mark and the switch portion are misaligned

In the power supply device of the present disclosure, the positioning projection and the finger catching portion are provide at a same short side of the first case. Accordingly, the covering portion is detached from the first case, by the finger catching portion at the engaging portion of the first case and the covering portion securely engaged by the positioning projection for positioning, and then such detaching process can be smoothly carried out.

A power supply device of the present disclosure connectable to electric equipment for supplying power, comprises a main body case divided into a first case and a second case, and having an extending shape in one direction, and a secondary battery incorporated in the main body case, and the second case has a box shape having a bottom portion, a pair of case side was in a longitudinal direction, and an inner peripheral wall disposed inside the case side walls and along the case side walls, and the inner peripheral wall has a pair of support walls to hold both sides of the secondary battery, the support walls are formed so as to extend upward along at least a part of the case side walls from the bottom portion of the second case, and the support walls are lower than the case side walls in height, and the upper end edges of the support walls are in contact with and support the first case, and the first case has inner side walls which are fitted between the case side walls and the inner peripheral wall.

In the power supply device of the present disclosure, each of the support walls is a U-shaped wall which comprises a portion parallel to the case side walls, and portions orthogonal to the case side walls

The power supply device of the present disclosure further comprises a circuit board disposed adjacent to the secondary battery in a extending direction of the secondary battery, and a heat radiation plate which is thermally coupled to heat generation parts of the circuit board and is disposed under the circuit board, and there is a space between the second case and the heat radiation plate.

In the power supply device of the present disclosure, the secondary battery is a prismatic secondary battery.

In the present disclosure, the holder side walls can support a part of the first case, and then the first case is supported by an area larger than a sectional area of the case side walls of the second case. The thickness of the case side walls is kept, and substantially it has the same strength as the thickness of the second case is enlarged. Especially, as the holder side walls for holding the secondary battery reinforce the side walls of the main body case, strength can be improved without increasing the number of parts, without enlarging the thickness of the case side walls.

In the present disclosure, as the inner peripheral wall of the second case is fitted to the inner side wall of the first case, strength is enlarged. Additionally, as the top end portions of the U-shaped walls contact the inner side of the upper portion of the first case, strength is enlarged against impact in the vertical direction.

As the prismatic secondary battery having a rectangular shape in a plan view is stored inside the U-shaped walls, the U-shaped walls position the secondary battery, and also keeps the space between the secondary battery and the case side walls, and then this space becomes a buffer zone against impact force from the outside, and the impact force is not directly applied to the secondary battery. Strength can be improved without enlarging the thickness of the case side walls.

### BRIEF DESCRIPTION OF DRAWINGS

FIG. 1 is a perspective view showing a portable power supply device related to one embodiment.

FIG. 2 is an exploded perspective view showing a state where electric equipment is connected to the portable power supply device of FIG. 1.

FIG. 3 is a perspective view showing a state where the electric equipment is mounted on the upper surface of the portable power supply device for charging.

FIG. 4 is an exploded perspective view showing a state where a covering portion is detached from the portable power supply device of FIG. 1.

FIG. 5 is an exploded perspective view showing a state where a main body case of FIG. 4 is disassembled into a first case and a second case.

FIG. 6 is an exploded perspective view from the diagonally lower side of the portable power supply device of FIG. 5.

FIG. 7 is an exploded perspective view showing a state where a circuit board and an incorporated battery are disassembled from a second case of FIG. 5.

FIG. 8 is a vertical sectional view along a line VIII-VIII in FIG. 1.

FIG. 9 is a vertical sectional view along a line IX-IX in FIG. 1.

FIG. 10 is a perspective view from the rear side of the portable power supply device of FIG. 1.

FIG. 11 is an exploded perspective view showing a state where the covering portion is detached from the portable power supply device of FIG. 10.

FIG. 12 is an exploded perspective view showing a state where posture of the covering portion in FIG. 11 is changed.

FIG. 13 is an exploded perspective view showing a state where the potable power supply device of FIG. 1 is charged with power line.

FIG. 14 is an exploded perspective view showing state where the portable power supply device of FIG. 1 is charged by non-contact, being mounted on a charging stand.

FIG. 15 is a perspective view from the diagonally lower side of the portable power supply device of FIG. 10.

FIG. 16 is a sectional view showing the portable power supply device related to the embodiment 2.

FIG. 17 is a sectional view showing the portable power supply device related to the embodiment 3.

FIG. 18 is a front view showing the portable power supply device related to the embodiment 4.

FIG. 19 is an exploded perspective view from the diagonally lower side of the portable power supply device related to the embodiment 5.

FIG. 20 is an exploded perspective view showing the portable power supply device related to the embodiment 6.

FIG. 21 is a plan view showing a portion to store a battery with the first case detached in the portable power supply device related to the embodiment 6.

FIG. 22 is an enlarged perspective view of XXII portion in FIG. 21.

FIG. 23 is a vertical sectional view along a line XXIII-XXIII in FIG. 21 in the portable power supply device related to the embodiment 6.

FIG. 24 is a vertical sectional view along a line XXIV-XXIV in FIG. 21 in the portable power supply device related to the embodiment 6.

FIG. 25 is an exploded perspective view showing a conventional portable power supply device.

### DESCRIPTION OF EMBODIMENTS

Hereinafter, the embodiment of the present invention will be described referring to drawings. Furthermore, in the description below, identical names and reference numbers represent identical or homogeneous members, and detailed descriptions are appropriately omitted. Moreover, mode may be applied where each element constituting the present invention constitutes a plurality of elements with the use of the same member, thereby serving the plurality of elements with the use of one member, or, in contrast, mode may be realized where a function of the one member is shared by a plurality of members. Also, a portion of examples and the content described in the embodiments can be applied to other examples and another embodiment.

### Embodiment 1

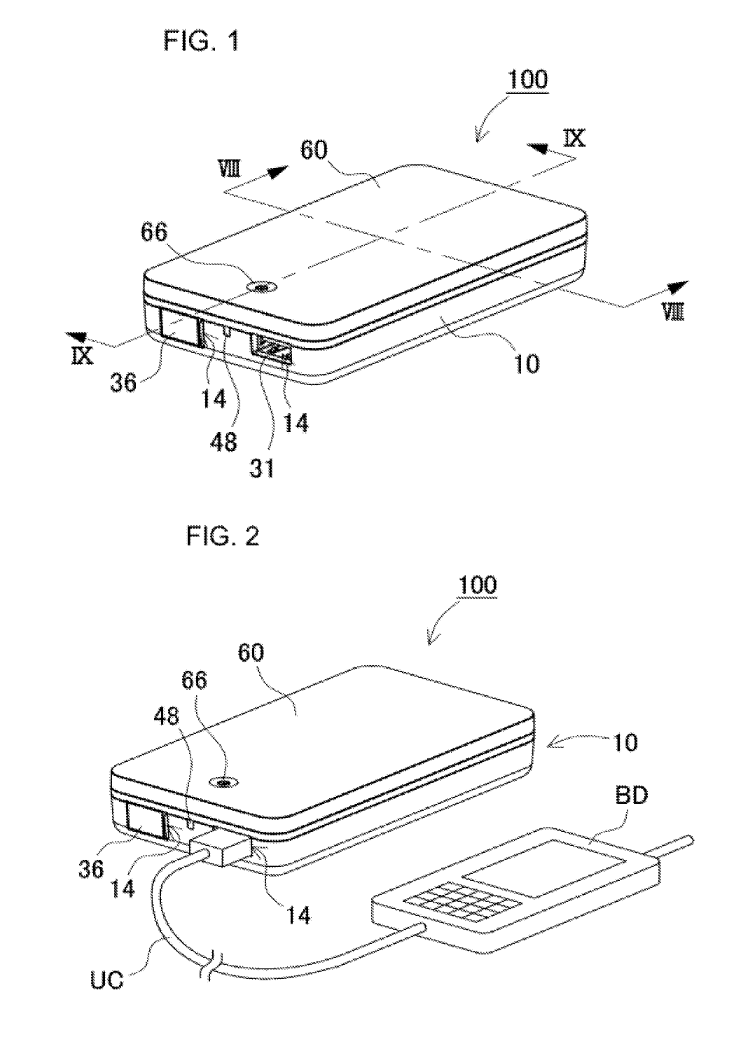

A portable power supply device 100 related to an embodiment 1 of the present invention is shown in FIG. 1 to FIG. 9.

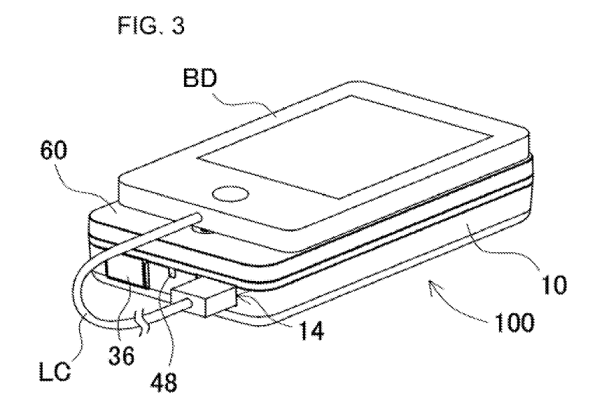

The portable power supply device 100 comprises a main body case 10, a battery holder 20 where secondary batteries 1 and a circuit board 30 are set in the main body case 10. In the portable power supply device 100, power of the secondary batteries 1 is discharged from an outer output terminal 31 exposed outside, and activates electric equipment BD, or charges a secondary battery incorporated in the electric equipment BD. In the example shown in FIG. 2, a mobile phone as the electric equipment BD is charged through a USB cable UC. Namely, in this example, the outer output terminal 31 is a USB terminal. Here, the outer output terminal of the present invention is not limited to the USB cable, and a terminal standardized by other specification or a terminal standardized by an own specification may be used. For example, in the example of FIG. 3, the lightening cable (product name) LC is used.

The electric equipment BD to which the portable power supply device 100 supplies power includes a mobile phone, a smart phone, a portable music player, a portable game device, a tablet type PC, or a note-book type PC, and also includes an auxiliary power supply device or a booster which charges these portable electric equipment devices.

The portable power supply device 100 shown in FIG. 1 to FIG. 9 comprises the main body case 10, the secondary batteries 1 stored in the main body case 10, the circuit board 30, the battery holder 20 for holding the secondary batteries 20, and a covering portion 60 covering the main body 10.

### (Main Body Case 10)

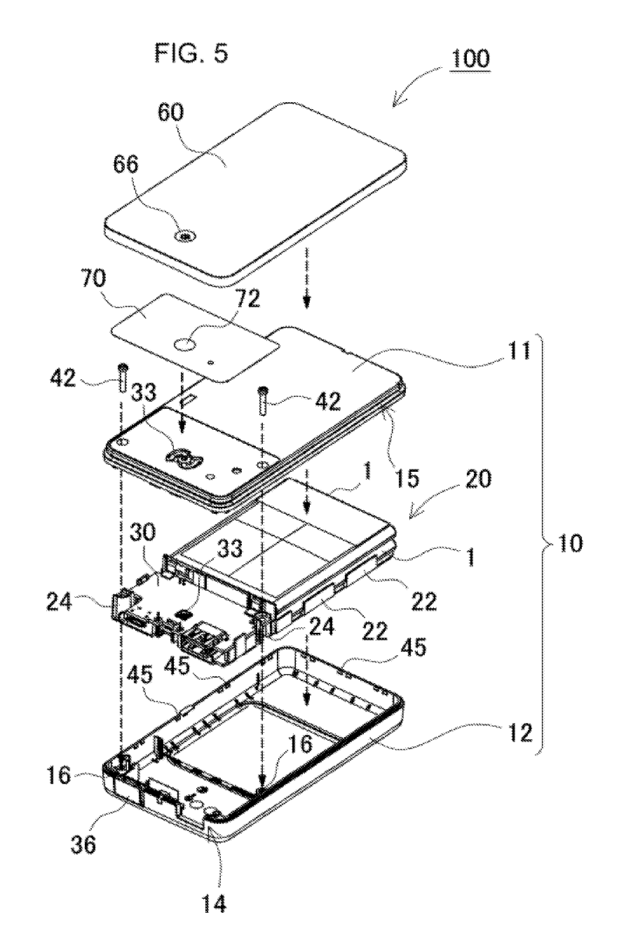

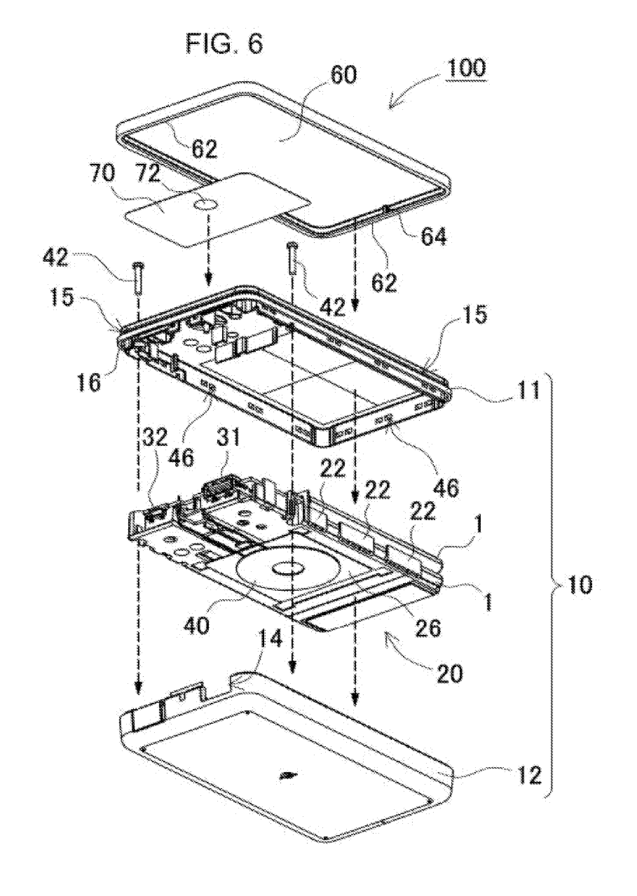

The main body case 10 has an approximate box shape extending in one direction. Corner rounding chamfering prevents other objects from being damaged at carrying it. As shown in exploded perspective views of FIG. 5 and FIG. 6, the main body case 10 is divided into two members of a first case 11 and a second case 12. In this example, the main body case 10 is divided at the horizontal plane, and the first case 11 configures the upper surface side, and the second case 12 configures the lower surface side. Therefore, the first case 11 is an upper case, and the second case 12 is a lower case. Each of the first case 11 and the second case 12 has a bottomed box shape. Further, the second case 12 has a pair of case side walls 12a along a longitudinal direction.

The first case 11 at the upper surface side of the portable power supply device 100 is covered with a covering portion 60. The covering portion 60 is made of flexible material. Concretely, it is made of silicone rubber.

The main body case 10 incorporates 2 pieces of the secondary batteries 1. These secondary batteries 1 are held by a battery holder 20. The battery holder 20 has a pair of holder side walls 22, and both sides of the secondary batteries 1 are sandwiched and fixed between the holder side walls 22 to hold the secondary batteries 1. The secondary battery 1 is a prismatic battery, in other words, a rectangular parallelepiped battery having the thickness smaller than the widths. By this, the secondary batteries 1 are efficiently disposed in the main body case, compared with the cylindrical secondary battery. It enables the main body case to be thinner. However, in the present invention, the secondary battery is not limited to the thin prismatic battery. For example, one thick prismatic battery, a polymer battery, or the cylindrical batteries arranged in the horizontal direction can be used. The known rechargeable secondary battery such as a lithium ion secondary battery, a nickel-hydrogen battery, or a nickel cadmium battery can be used as the secondary battery.

The main body case 10 constituting the outer appearance of the portable power supply device 100 has a box shape to chamfer the outer shape. The main body case 10 has a rectangular shape in a plan view to chamfer the corners. By chamfering, edge portions are decreased, and then it is convenient for carrying. In a side view, it has a rectangular shape having the thickness smaller the width, and the corners at the bottom surface side are chamfered. As the corners of the upper surface side are not chamfered, and as shown in FIG. 3, in order to mount the electric equipment BD on the upper surface for charging, the electric equipment BD is easily mounted, and it is difficult that the electric equipment BD slips down from the upper surface, since the upper surface for mounting is flat.

This main body case 10 is made of a resin having an excellent insulation property, for example, such as polycarbonate resin. The size of the main body case is designed such that two pieces of the thin type of the secondary batteries 1 are stacked and the circuit board 30 is disposed at one end side in the longitudinal direction in the main body case 10.

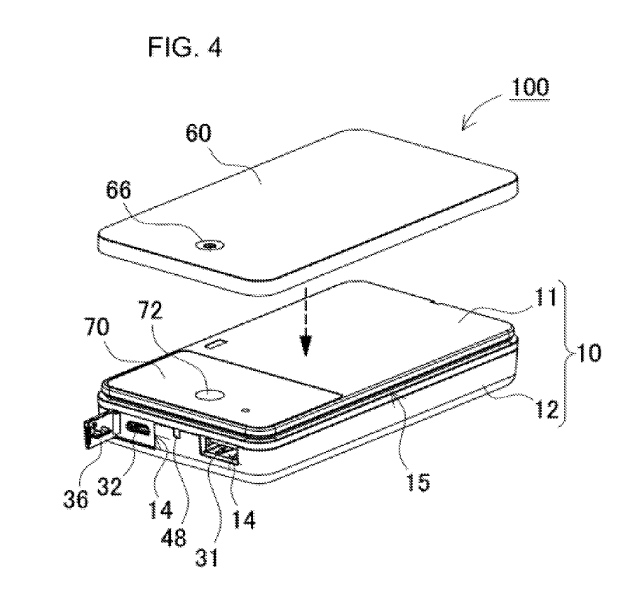

As shown in an outer perspective view of FIG. 1 and an exploded perspective view of FIG. 4, the outer output terminal 31 and a power supplied terminal 32 are provided at the end surface in the longitudinal direction of the main body case 10. At the end surface of the main body case 10, terminal windows 14 are formed to expose the outer output terminal 31 and the power supplied terminal 32. Standardized terminals are used as the outer output terminal 31 and the power supplied terminal 32, and then the versatility can be enhanced. In the example of FIG. 2, USB terminals which are widely used is adopted, and the outer output terminal 31 is the USB terminal (A terminal), and the power supplied terminal 32 is the micro USB terminal.

As shown in FIG. 5, a switch portion 33 is provided on the upper surface of the main body case 10. The switch portion 33 is a power switch, or a discharge starting switch.

The switch portion 33, the outer output terminal 31, and the power supplied terminal 32 are mounted on the circuit board 30 described below. The circuit board 30 is fixed at the battery holder 30. In a state where the battery holder 20 is stored in the main body case 10, the switch portion 33, the outer output terminal 31, and the power supplied terminal 32 are exposed through the terminal windows 14 opened in the main body case 10.

As shown in FIG. 5 and FIG. 6, the main body case 10 is divided into the two pieces of the first case 11 and the second case 12. The first case 11 and the second case 12 are fixed by a fitting structure and screws 42. As the fitting structure, hook portions 45, hook receiving portions 46 are respectively disposed along the periphery of the first case 11, the second case 12, at plural locations where the hook portions 45 of the first case 11 corresponds to the hook receiving portions 46 of the second case 12. The hook portions 45, the hook receiving portions 46 are respectively disposed in spaced relationship with each other. In the example of FIG. 5 and FIG. 6, the second case 12 has the hook portions 45, and the first case 11 has the hook receiving portions 46. On the contrary, the first case may have the hook portions, and the second case may have the hook receiving portions. As the fitting structure, other known fitting structures other than the hook portion and hook receiving portion can be properly used. Further, the first case and the second case can be connected by ultrasonic welding.

Bosses 16 for fixing by screw are provided in each of the internal surfaces of the first case 11 and the second case 12. The bosses 16 are provided at two locations. Further, holder side bosses 24 for penetrating are provided also at the battery holder 20. These bosses 16 are disposed in spaced relationship with each other on a diagonal line of the circuit board 30. In other words, as the bosses are not disposed at a portion where the secondary battery 1 is stored, it prevents the main body case from being enlarged by providing the bosses. The boss for fixing by screw is not provided around the secondary battery 1, but by the above fitting structure, the first case 11 and the second case 12 are coupled. Thus, by both of fixing by screw and the fitting structure, the coupling structure of the first case and the second case becomes compact, and then coupling strength is kept.

### (Covering Portion 60)

As mentioned above, the main surface of the first case 11 is covered with the flexible covering portion 60 made of silicone. By covering the upper surface of the main body case 10 with the covering portion 60 having flexibility, in a case where the electric equipment for receiving power is mounted on this upper surface as the mounting surface, the electric equipment during receiving power is stably held since friction coefficient of the mounting surface is high, and it prevents the electric equipment from slipping down. At the time of carrying it, in a case where external force is applied or added to the upper surface by dropping it or impact against other members, stress is relaxed, and then members stored inside are protected. Further, the upper surface of the main body case or the electric equipment mounted on this upper surface is prevented from being damaged.

Additionally, the covering portion 60 is removably attached. For example, the covering portions 60 having different designs in a color tone or a pattern are prepared, and then the covering portion 60 can be charged to another design for enjoying.

The thickness of 3 mm or more in the first case 11 can withstand the impact force of 55 J, and the sink generated in the first case 11 is covered with the covering portion 60. In another way, the thickness of the first case 11 is 2.5 mm to 3.0 mm, and the thickness of the covering portion 60 is 1.0 mm to 2.0 mm. Therefore, the sink of the first case 11 is not generated. As the total thickness of the first case 11 and the covering portion 60 is 3.5 mm to 5.0 mm, it can withstand the impact force of 55 J. The portable power supply device 100 has the outer appearance without the sink, and withstands the impact force of 55 J from the outside.

### (Cover Projecting Portion 62)

This cover portion 60 has a cover projecting portion 62 which projects inward in approximate parallel with and in spaced relationship with the main surface. A fitting groove 15 into which the cover projecting portion 62 is fitted, is formed at the side walls of the first case 11. By this structure, the covering portion 60 and the main body case 10 are strongly coupled. At the time of carrying the portable power supply device, for example, when the portable power supply device put in a bag contacts other members, the covering portion is prevented from abruptly coming off.

By enhancing the hardness of the covering portion 60, it prevents the covering portion 60 from being easily deformed, and then the covering portion 60 is more prevented from coming off. For example, it is preferable that the hardness of the covering portion 60 is Hs 40 to Hs 70. By this, the deformation of the covering portion is suppressed so as not to easily come off, and at the time of carrying the portable power supply device, the covering portion is prevented from abruptly coming off.

It is preferable that a projection length of the cover projecting portion 62 which is fitted into the fitting groove 15 is appropriately kept and it increases the strength of fitting. For example, the projection length of the cover projecting portion 62 which is fitted into the fitting groove 15 is 1.1 mm to 2.0 mm. Thus, as it has adequate friction strength and holding strength, the covering portion cannot easily come off the first case.

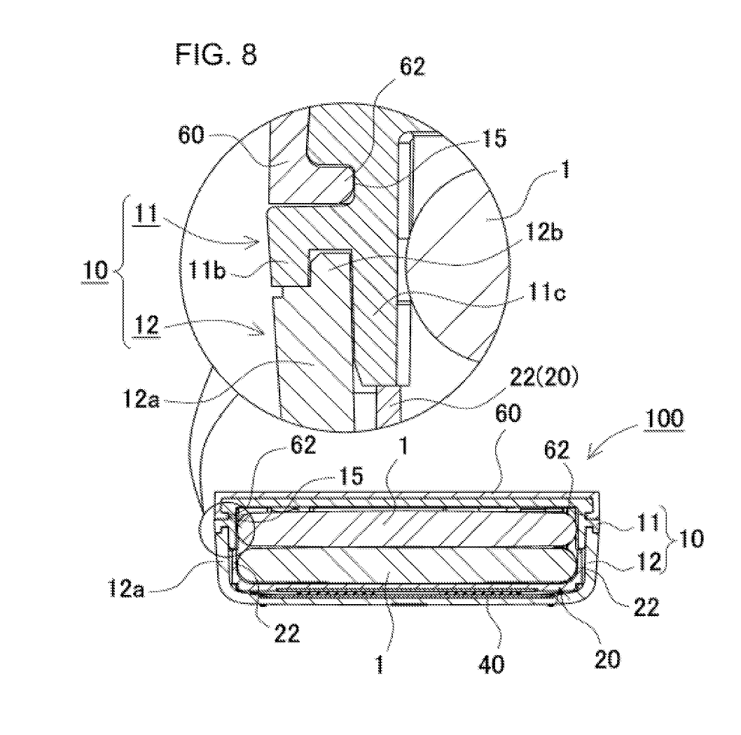

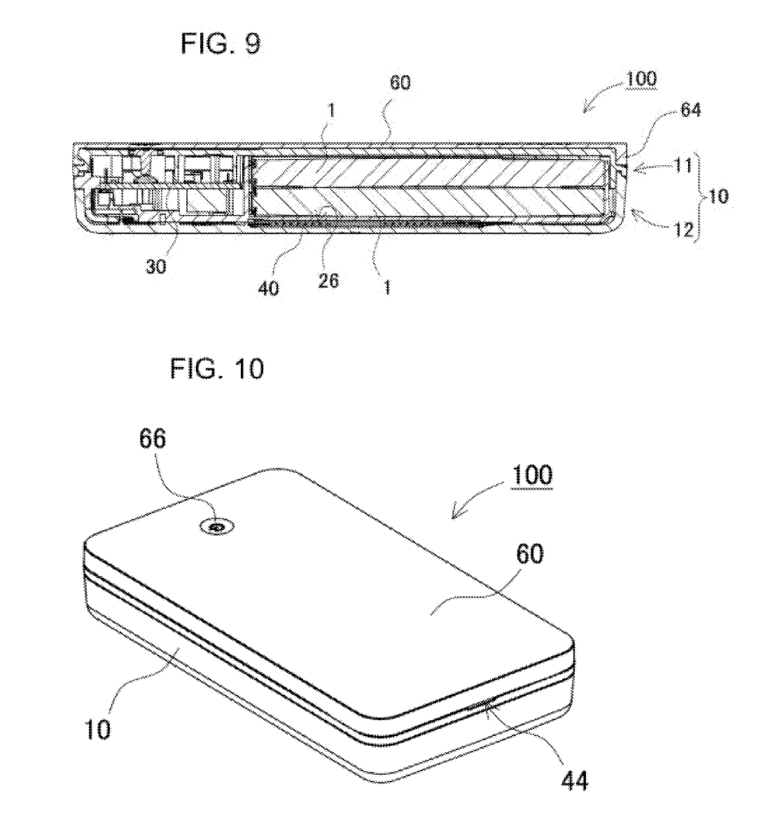

In a state where the first case 11 is covered with the covering portion 60, it is preferable that the side surface of the covering portion 60 and the side surface of the main body case 10 are disposed in the approximately same plane. As shown in an enlarged sectional view of FIG. 8 and a sectional view of FIG. 9, in a state where the first case 11 is covered with the covering portion 60, as the covering portion 60 does not project from the side surface of the main body case 10, it is prevented that a projecting covering portion is caught and abruptly comes off at the time of carrying the portable power supply device. A sense of unity between the covering portion 60 and the main body portion 10 is produced, and unity in design is shown.

### (Finger Catching Portion 44)

On the contrary, when coupling strength between the covering portion and the main body case is enhanced, it is difficult to detach the covering portion at changing the covering portions. In the embodiment 1, as shown in FIG. 10, a finger catching portion 44 which is partially recessed in the surface of the first case 11 at the boundary adjacent to the covering portion 60, is formed. As a user hooks a finger at the finger catching portion 44 at changing the covering portions, the covering portion 60 is easily detached and changed. Especially, tensile strength of the covering portion 60 is weak around the center in the longitudinal direction, and then the covering portion 60 easily comes off. When the finger catching portion 44 is provided at this location, the covering portion 60 more easily comes off. As the finger catching portion 44 is provided in the short direction perpendicular to the longitudinal direction, it is prevented from easily coming off.

It is preferable that the finger catching portion 44 is provided at a location where coupling of the first case and the covering portion is weak. In this example, the finger catching portion 44 which is partially recessed at the approximate center of the short direction in the surface of the first case 11 at the boundary adjacent to the covering portion 60, is formed. As the corner portions of the covering portion 60 are tightly coupled to the first case 11, the covering portion 60 is not easily detached. In contrast, as tensile strength of the covering portion 60 is weak around the center in the longitudinal direction, when the finger catching portion 44 is formed at this location, there is a possibility that the covering portion 60 unintentionally come off by contacting other members. Therefore, as the finger catching portion 44 is formed at the short side where there is a low possibility that it contacts other members, the covering portion is prevented from abruptly coming off. In the embodiment 1, as shown in a perspective view from the rear side of FIG. 10, the finger catching portion 44 is formed at the rear side. By this way, the finger catching portion 44 does not interfere with the outer output terminal 31 or a display portion 48 at the front side. In other words, the finger catching portion 44 can be provided without making the structure of the main body case 10 complicated. Further, when a user hooks a finger at the finger catching portion 44, it is prevented that the finger contacts the outer connecting terminals or the display portion 48 and these members becomes unclean by dirt or oil attached to the finger and are damaged. In this way, by enhancing the hardness of the covering portion 60, the covering portion 60 does not easily come off at usage, and then changing work is easily carried out.

### (Battery Holder 20)

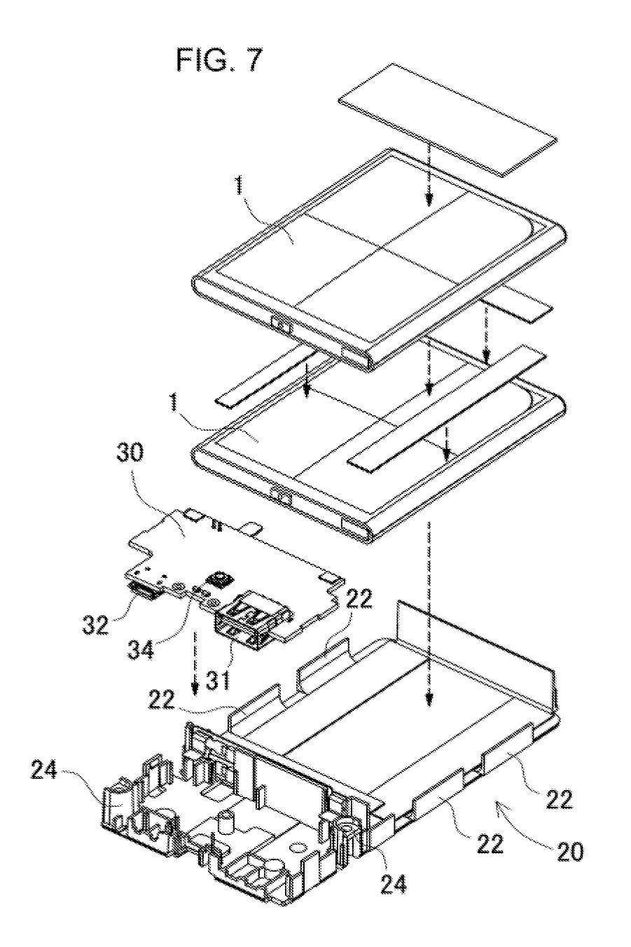

The battery holder 20 holds the secondary batteries 1 or the circuit board 30 in the main body case 10, and positions those. As shown in a exploded perspective view of FIG. 7, in the battery holder 20, two sheets of the secondary batteries 1 are stacked and disposed, and the circuit board 30 is disposed in the longitudinal direction of the secondary batteries 1. By this disposition, heat radiation of the secondary batteries 1 can be improved. Namely, in a conventional structure, as the circuit board and the secondary battery are stacked, heat radiation of the secondary battery may be prevented by heat generation of power semiconductor element or the like included in the circuit board. In contrast, in the structure of FIG. 7, the circuit board 30 is not disposed on the battery, but is disposed at the end edge side of the secondary battery 1. Therefore, heat generation of members included in the circuit board 30 does not influence the secondary battery 1, and then heat radiation of the secondary battery 1 and the members included in the circuit board 30 can be improved. In addition, in the structure where the circuit board is disposed on the battery, the thickness is increased, and then the size is enlarged. The portable power supply device 100 has a good design without enlargement of the size.

Here, the battery holder 30 stores two sheets of the prismatic batteries of the secondary batteries 1 in a state of being stacked. However, the portable power supply device 100 does not limit the secondary battery to two sheets, and can use one sheet, or three or more sheets. The number of the secondary battery 1 is decided based on needs of required capacity, outer appearance shape, or weight.

The two sheets of the prismatic batteries are stuck with two-faced adhesive tapes. As shown in a sectional view of FIG. 8, FIG. 7, the two-faced adhesive tapes have extending strip shapes along the longitudinal direction of the main body case 10, and are respectively stuck on both sides of the prismatic battery. In other words, the two-faced adhesive tapes are not stuck at the center area of the prismatic battery, and there is a space at the center area. By this, even though the prismatic batteries are swelled by charging and discharging, the space can absorb deformation of the outer can a little.

The holder side walls 22 of the battery holder 20 also reinforce side walls of the main body case 10 in a state where the battery holder 20 is stored in the main body case 10. Concretely, the holder side walls 22 are formed so as to extend upward along at least a part of the pair of the case side walls 12a from the bottom portion of the second case 12 in a state where the battery holder 20 is stored in the main body case 10.

The end edges where side walls of the first case 11 and the side walls of the second case 12 are joined, have step shapes in a vertical sectional view perpendicular to the longitudinal direction. As shown in the enlarged sectional view of FIG. 8, the second case 12 has a step-shaped projection 12b at which the end edge sides of the pair of the case side walls 12a provided along the longitudinal direction extend toward the first case 11 side at an inner surface side of the main body case 10.

The first case 11 has an outer surface extending portion 11b at which the end edge side of the first case 11 extends toward the second case 12 side at an outer surface side of the main body case 10, and also has an inner surface extending portion 11c at which the end edge side of the first case 11 extends along an inner surface of the second case 12. In a state where the first case 11 and the second case 12 are joined, the step-shaped projection 12b of the end edge of the second case 12 is sandwiched and fixed between the outer surface extending portion 11b and the inner surface extending portion 11c. By this spigot joint structure, the joint surfaces or portions of the first case 11 and the second case 12 are strongly coupled, and strength of the side walls in the main body case 10 is enhanced.

Further, as the portable power supply device is carried and used, appropriate strength is required. More improvement of strength is required to withstand impact of dropping or the like. However, when the thickness of the main body case is large, the size is increased, and also there is a problem that the sink of a resin is generated when hardening a resin in resin molding and an outer appearance or strength becomes bad. Especially, when the secondary battery is charged by non-contact charging as mentioned below and a power reception coil 40 is disposed on the bottom surface of the main body case, it is necessary to thin the thickness of the bottom surface of the main body case to closely dispose these coils for enhancing electromagnetic coupling efficiency of the power reception coil 40 and a power transmission coil 51. As a result, in the thickness of the main body case, the bottom surface is thin, and the side surface is thick, and then the thickness is uneven, and the sink is more remarkably generated.

In this embodiment, to improve strength without enlarging the thickness of the main body case, the holder side walls 22 of the battery holder 20 are used. Namely, the holder side walls 22 and the side wall of the second case 12 are overlapped, and both of them support the end edge of the first case 11. Substantially, it has the same effect as the thickness of the second case 12 is enlarged, strength in the side walls of the main body case can be improved.

Concretely, as shown in FIG. 8, the holder side walls 22 of the battery holder 20 are formed so as to extend upward along at least a part of the pair of the case side walls 12a from the bottom portion of the second case 12. The upper end edges of the holder side walls 22 support a lower end edge of the inner surface extending portion 11c by contacting. By this structure, the holder side walls 22 can support a part of the first case 11, and then the first case 11 is supported by an area larger than a sectional area of the case side walls 12a of the second case 12. The thickness of the case side walls 12a is kept, and substantially it has the same strength as the thickness of the second case 12 is enlarged. Especially, as the holder side walls 22 for holding the secondary battery 1 reinforce the side walls of the main body case 10, strength can be improved without increasing the number of parts, without enlarging the thickness of the case side walls 12a.

For example, the thickness of the case side wall 12a, and the thickness of the holder side wall 22 of the battery holder 20 are set at 1.0 mm to 2.5 mm, and then the sink in the case side wall 12a is not generated. The total thickness of the case side wall 12a and holder side wall 22 is set at 3.0 mm to 5.0 mm, and then its strength withstands impact of 55 J. Thus, the sink in the outer appearance of the portable power supply device 100 is extremely suppressed, and the portable power supply device 100 has strength withstanding impact of 55 J form the outside.

Each of the holder side walls 22 is lower than each of the case side walls 12a in height. In other words, the joining surfaces of the inner surface extending portion 22 and the inner surface extending portion 11c of the first case 11 are located inside the case side wall 12a of the second case 12. Thus, the inner surface extending portion 11c is guided or supported by an inner surface of the case side walls 12a, and the undersurface of the inner surface extending portion 11c is supported by the upper surface of the holder side wall 22, and then the contacting surfaces of the holder side walls 22 and the inner surface extending portion 11c are stabilized.

The extending length toward the second case 12 side of the outer surface extending portion 11b is shorter than that of the inner surface extending portion 11c. Thus, the region where the thickness of the first case 11 and the second case 12 is thin, is reduced, and then decrease of strength of the case side walls 12a is suppressed. As mentioned above, the inner surface extending portion 11c makes the region which is supported by the inner surface of the case side wall 12a large, and then the contacting surfaces to the holder side wall 22 can be stabilized.

As shown in the vertical sectional view of FIG. 8, it is preferable that the holder side wall 22 do not contact the surface of the case side wall 12a, but is disposed in spaced relationship with the case side wall 12a. Thus, such a space functions as a buffer region which absorbs manufacturing allowance of the incorporated secondary battery 1 or deformation of the swollen outer can of the secondary battery 1 by charging and discharging of large currents.

Preferably, in the holder side wall 22 in the side surface of the longitudinal direction, a plurality of the holder side walls 22 are provided in spaced relationship with each other. Thus, the whole surface of the side surface of the secondary battery 1 is not covered with the holder side wall 22, but the secondary battery 1 is partially exposed, and then it absorbs manufacturing allowance of the secondary battery 1 or swollen deformation in the same way as above.

In the above example, the step-shaped structure at the joint boundary of the first case 11 and the second case 12 is continuously provided along the long direction, except for the side surface where the outer connecting terminals are provided, in other words, also at the side surface in the short direction in addition to the side surfaces in the longitudinal direction. As shown in FIG. 7, the holder side walls 22 of the battery holder 20 are formed in a state where spaces are provided partially at the side surfaces in the longitudinal direction. However, it is not limited to this structure, for example, the holder side walls 22 can be formed so as to continuously extend along the side surfaces in the longitudinal direction, or the holder side walls 22 can be provided along the side surfaces of the short direction.

### (Circuit Board 30)

The circuit board 30 can include electric circuits such as a power conversion circuit for converting discharging current of the secondary battery 1, or a monitoring circuit for monitoring temperature of the secondary battery 1 or battery voltage. Here, in the example of FIG. 7, as the two sheets of the secondary batteries 1 are electrically connected in parallel to each other, the total voltage of the secondary batteries is equal to battery voltage in each of the secondary batteries 1. For example, when the secondary batteries are electrically connected in series, electric potential of a lead plate connecting the secondary batteries is measured, and then battery voltage in each of the secondary batteries is detected. A temperature sensor is connected to the secondary batteries 1, and the monitoring circuit monitors so as not to exceed a predetermined threshold based on the detected temperature. When the temperature exceeds the threshold temperature, a process of stopping charging or discharging is carried out.

The circuit board 30 has the outer output terminal 31 and the power supplied terminal 32. In a state where the USB connector as the outer output terminal 31 is mounted directly on the circuit board 30, the circuit board 30 is fixed to the battery holder 20, and those are stored in the main body case 10, and then the outer output terminal 31 is exposed from the terminal window 14. Thus, the outer output terminal 31 is positioned, and the outer output terminal 31 is configured to be exposed from the predetermined terminal window 14 by assembling. In the same way, as the power supplied terminal 32 is mounted at the predetermined location on the circuit board 30, the power supplied terminal 32 is configured to be exposed from the predetermined terminal window 14 of the assembled main body case 10. The power switch 34 is mounted at a location corresponding to the switch portion 33 on the circuit board 30.

### (Display Portion 48)

The circuit board 30 has the display portion 48 which shows operating states of the portable power supply device 100. Here, in the display portion 48, light emitting element shows a charging state or a discharging state of the secondary battery 1 with light colors or lighting patterns. As a light emitting element, a semiconductor light emitting element of LED which is low power consumption, a long life, and strong to mechanical impact can be suitably used. As shown in FIG. 1, the display portion 48 is exposed at the side surface of the main body case 10. As shown in FIG. 7, light from LED mounted on the circuit board 30 is guided to the side surface of the main body case 10 through a lamp reader. Thus, even though the upper surface of the main body case 10 is covered with the covering portion 60, the display portion 48 can be confirmed by sight from the outside, and then a user can see the operating states. Namely, in a conventional portable power supply device, a pilot lamp is usually disposed on the upper surface of the main body case. When the whole upper surface of the main body case is covered with the covering portion, it is difficult to see light emitting from the outside. Especially, in a case where the covering portion can be changed for different colors, when the covering portion has deep color of navy blue color or pink color, it is more difficult to see light emitting from the display portion 48 through the covering portion having high light shielding effect. In contrast, as the display portion 48 is disposed at the side surface, this problem is prevented, and then while the upper surface of the main body case 10 is covered with the covering portion 60, the operating states can be notified to a user through the display portion 48.

Preferably, the side surface where the display portion 48 is provided, is a surface where the outer connecting terminals are exposed. Thus, when a user uses the portable power supply device and the outer connecting terminals for electrical connection, the user pays attention to the display portion 48 disposed in the vicinity of it. As the display portion 48 for showing the operating state is disposed at the surface to which the user necessarily pays attention, the display portion 48 can be easily confirmed by sight.

### (Terminal Cover 36)

If necessary, the outer connecting terminal can have water proof, dust proof structure where a terminal cover 36 closes the terminal window 14. In the example shown in FIG. 4, a cap made of rubber is provided at the terminal window 14 of the power supplied terminal 32, and closes the power supplied terminals 32. Further, such a cap (not shown in figures) may be provided at the terminal window of the outer output terminal.

### (Cover Side Switch Mark 66)

The covering portion 60 has a cover side switch mark 66 which indicates that the switch portion 33 exists thereunder at a location corresponding to the switch portion 33 in a state where the covering portion 60 covers the first case 11 as shown in FIG. 1 or FIG. 4. Thus, even though the covering portion 60 covers the first case 11, a user can confirm by sight the location of the switch portion 33 by using the cover side switch mark 66, and then the user can operate the switch portion 33 through the covering portion 60.

### (Label Portion 70)

Similarly, a switch mark can be provided also at the first case 11 side. In the example shown in FIG. 4 or FIG. 5, a label portion 70 is stuck on the upper surface of the first case 11 so as to cover the switch portion 33. The label portion 70 has a label side switch mark 72 which indicates that the switch portion 33 exists thereunder at a location corresponding to the switch portion 33. Thus, a user can confirm by sight the location of the switch portion 33 by using the label side switch mark 72, and then the user can operate the switch 33 through the label 70. Especially, the location of the switch portion 33 can be confirmed by sight even in a state where the covering portion 60 is detached, and then the portable power supply device can be used even without the covering portion. As the label side switch mark 72 is also printed on the label where specification or the like is described, a number of parts is decreased, and manufacturing cost can be reduced.

Preferably, the label side switch mark 72 is formed by embossing. Thus, the user can search the location of the switch through feeling of the finger tips, and the user can easily operate the switch in the dark or when it cannot be seen.

### (Positioning Structure)

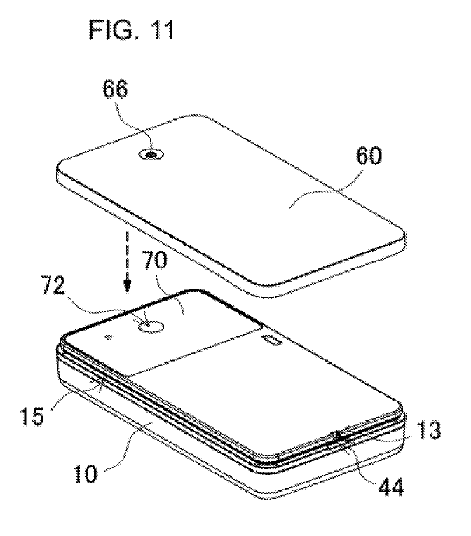

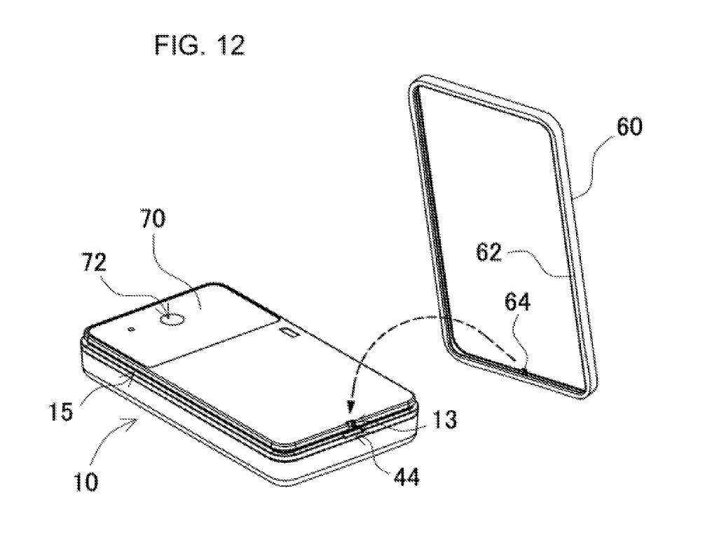

Preferably, the covering portion 60 has a positioning structure where the covering portion 60 does not cover the first case 11 in a reverse posture to the proper covering posture in the longitudinal direction. This example is shown in FIG. 10 to FIG. 12. In the example shown in these figures, as shown in an exploded perspective view of FIG. 12, the covering portion 60 has a positioning projection 64 for positioning at the location which is not symmetrical with respect to the center in the longitudinal direction on the inner surface of the cover projecting portion 62. As shown in the exploded perspective views of FIG. 11 and FIG. 12, in the first case 11, a positioning recess portion 13 is formed so as to be engaged with this positioning projection 64 at a location corresponding to the positioning projection 64. Thus, the positioning projection 64 is engaged with the positioning recess portion 13, and then the fitted state of the covering portion 60 and the first case 11 can be strengthened. In addition, as the covering portion 60 is not symmetrical, it prevents the covering portion 60 from being set in the reverse posture. Especially, when the switch portion 33 is provided at the location which is not symmetrical in the longitudinal direction and the cover portion 60 is set in the reverse posture to the proper covering posture, the locations of the cover side switch mark 66 and the switch portion 33 are misaligned, and then the user cannot operate the switch. However, the positioning structure is provided to prevent setting in the reverse posture, this trouble can be avoided.

Here, the positioning projection 64 and the above-mentioned finger catching portion 44 for detaching the covering portion 60 can be provide at the same short side of the first case 11. Thus, the covering portion 60 is detached from the first case 11, by the finger catching portion 44 at the engaging portion of the first case 11 and the covering portion 60 securely engaged by the positioning projection 64 for positioning, and then such detaching process can be smoothly carried out.

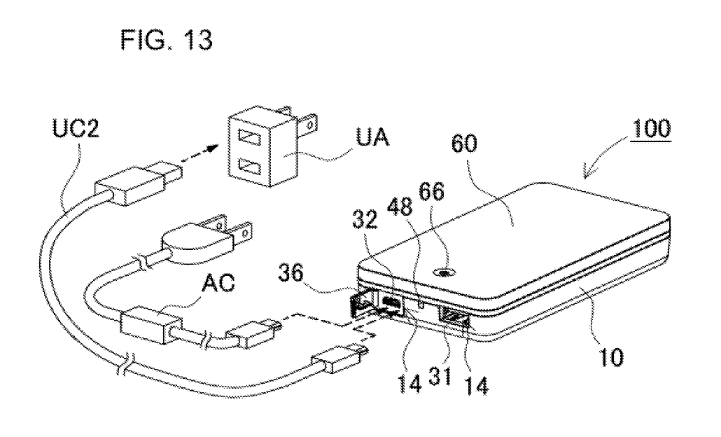

As mentioned above, this portable power supply device 100 is connected to the external electric equipment BD as shown in FIG. 2 and FIG. 3, and provides power to the electric equipment BD to activate the electric equipment BD. In place of or in addition to this, the secondary battery incorporated in the electric equipment BD is charged. In contrast, when the remaining capacity of the secondary battery 1 is decreased, as shown in FIG. 13, a USB cable UC2 or the like is connected to the power supplied terminal 32, and then the secondary battery 1 can be charged with power supply from the commercial power supply through an external AC adapter AC, a USB power supply adaptor UA, or the like.

### (Non-Contact Charging)

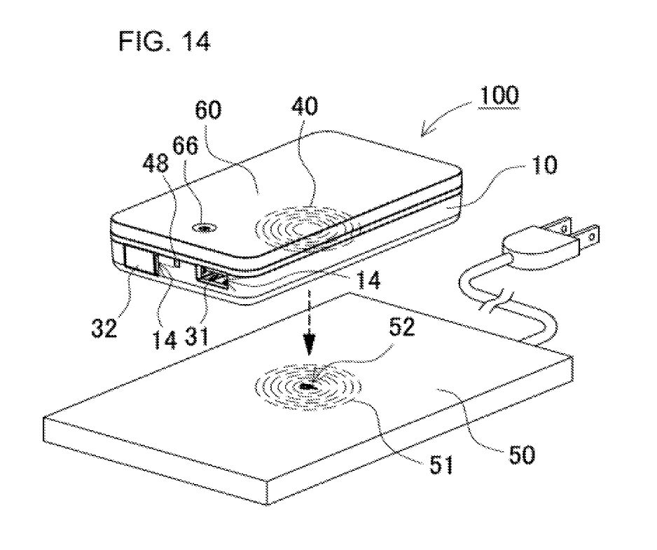

As shown in FIG. 14, this portable power supply device 100 is set on a charging stand 50, and enables the secondary battery to be charged with power transmitted from the charging stand 50 by non-contact charging. As shown in the exploded perspective view of FIG. 6, the potable power supply device 100 includes the power reception coil 40. The power reception coil 40 is fixed in a coil storing portion 26 which is formed at the rear side of the battery holder 20. End edges of the power reception coil 40 are connected to a charging circuit included in the circuit board 30. As shown in the vertical sectional views of FIG. 8, FIG. 9, this power reception coil 40 is fixed facing to the inner surface side of the second case 12, and the portable power supply device 100 is set on the charging stand 50, and then the power reception coil 40 is brought close to the charging stand 50.

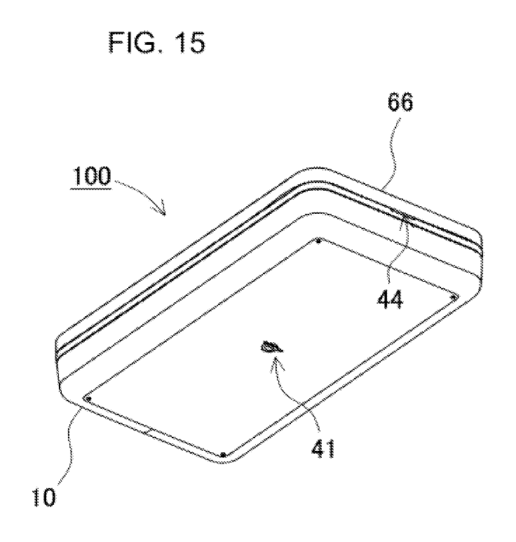

In contrast, the power transmission coil 51 is provided in the charging stand 50 side, and the power reception coil 40 can receive power from the power transmission coil 51 by the electromagnetic coupling of the power reception coil 40 and the power transmission coil 51, and the secondary battery can be charged by power conversion of this. It is necessary to set the portable power supply device 100 on the charging stand 50 so that the power transmission coil 51 of the charging stand 50 and the power reception coil 40 face to each other to carry out the non-contact charging. Therefore, a positioning system is provided between the portable power supply device 100 and the charging stand 50. As such a positioning system, in the example of a perspective view from the bottom side of FIG. 15, a power reception side mark 41 is displayed at a location where the power reception coil 40 of the portable power supply device is provided. In contrast, as shown in FIG. 14, a power transmission side mark 52 is displayed at a location where the power transmission coil 51 is provided on the charging stand side. Thus, a user can set the portable power supply device on the charging stand 50 so that the power reception side mark 41 coincides with the power transmission side mark 52, and then the power reception coil 40 can be positioned to the power transmission coil 51.

### Embodiment 2

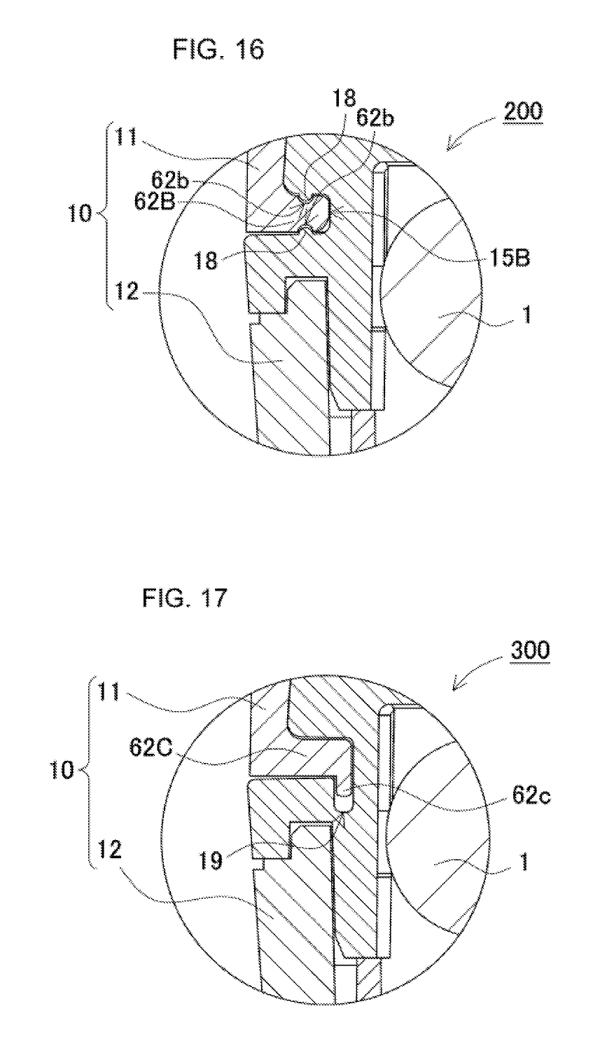

The shape of the cover projecting portion is not limited to the above embodiment 1, and its other shapes can be properly selected to prevent it from unintentionally coming off main body case. For example, in the portable power supply device 200 in a sectional view of FIG. 16 as the embodiment 2, projecting strips 18 are formed at the inner surface of the fitting groove 15B into which the cover projecting portion 62B is fitted, and recess portions 62b into which the projecting strips 18 are fitted are formed at locations corresponding to the cover projecting portion 62B. As by the fitting structure of the projecting strips 18 and the recess portions 62b, the cover projecting portion is held by the fitting groove 15B, the cover projecting portion does not easily come off the fitting groove 15B. Especially, the projecting strips 18 are provided in the upper side and lower sides at the inner surface of the fitting groove 15B, and the recess portions 62b are also provided in the upper side and lower side of the cover projecting portion, and then the cover projecting portion is surely fitted from both sides.

### Embodiment 3

In the portable power supply device 300 in a sectional view of FIG. 17 as the embodiment 3, a bending portion 62c at which the tip portion of the cover projecting portion 62C is bent downward is provided. In the first case 11, a recess portion 19 for guiding this bending portion 62c is formed. Thus, in a state where the covering portion 60 is set to the first case 11, the cover projecting portion is inserted into the fitting groove, and the bending portion 62c is fitted into the recess portion 19, and then the tip is held. Then, the cover projecting portion is prevented from coming off.

### Embodiment 4

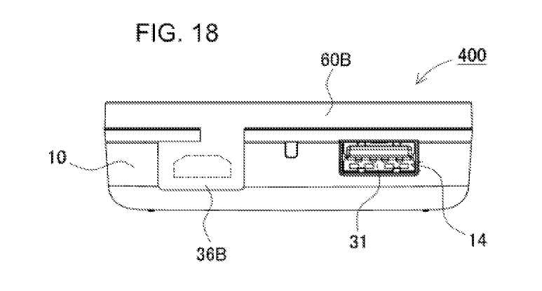

The terminal cover is made as a separate part, or the terminal cover and the covering portion can be made as one part. For example, in the portable power supply device 400 in a sectional view of FIG. 18 as the embodiment 4, the covering portion 603 is integrally formed as one part with a terminal cover 363 to close the terminal window. Then, members are used as a common part, and cost is reduced, and additionally the small terminal cover is prevented from coming off and being lost.

### Embodiment 5

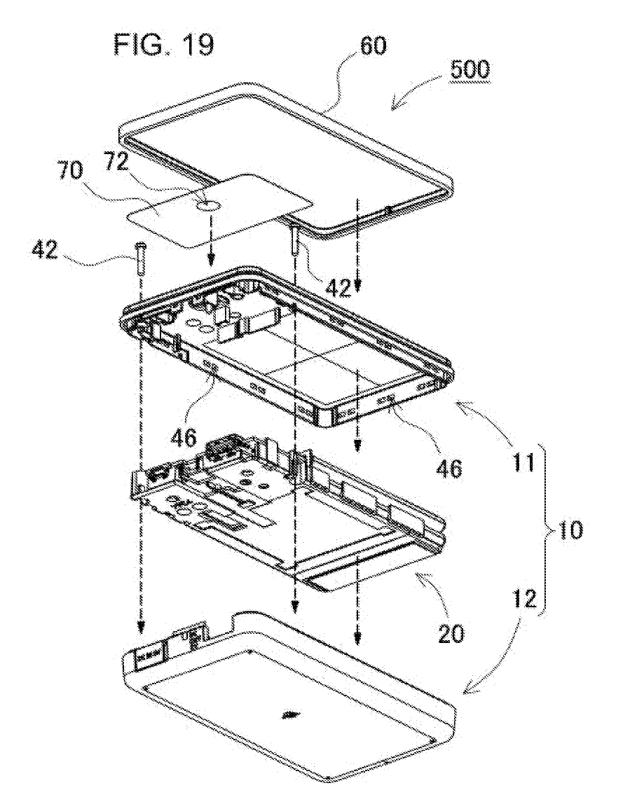

In the above example, the portable power supply device is charged by line connection and non-contact method, but the portable power supply device of the present invention is not limited to the type having a function of non-contact charging. The example of the portable power supply device without the function of the non-contact charging is shown in an exploded perspective view of FIG. 19 as the embodiment 5. The portable power supply device 500 does not have the power reception coil, and other members or parts are common with the embodiment 1 and the same marks as the embodiment 1 are shown, and then detailed explanation is omitted. In this portable power supply device 500, the secondary battery 1 is charged by power line. By omitting the power reception coil, its structure is simplified, and cost is reduced.

### Embodiment 6

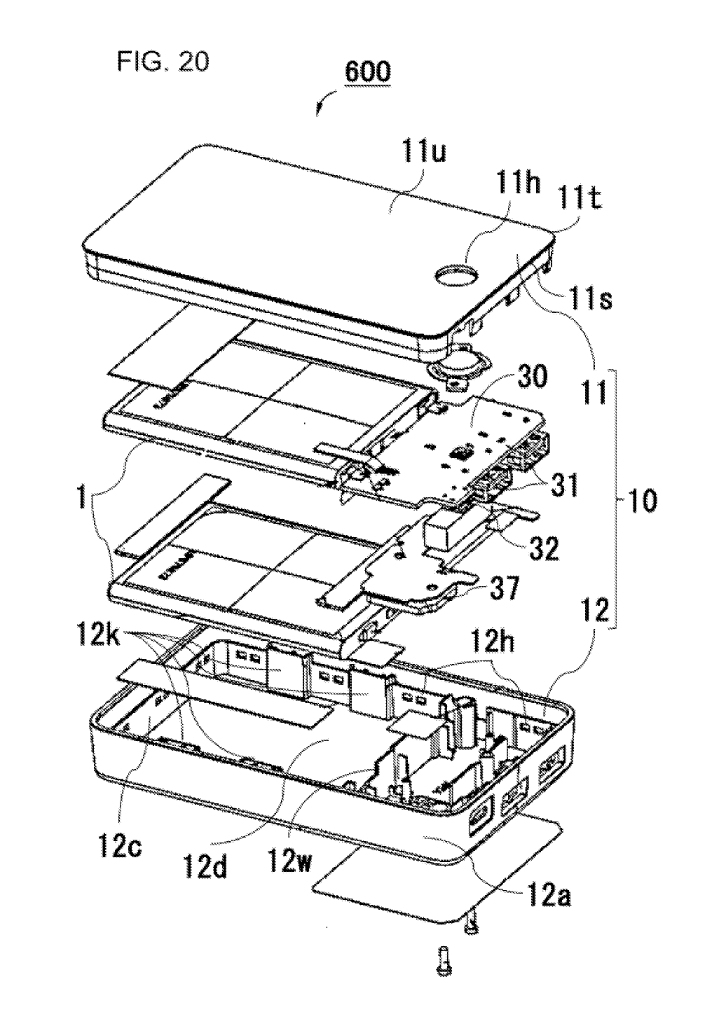

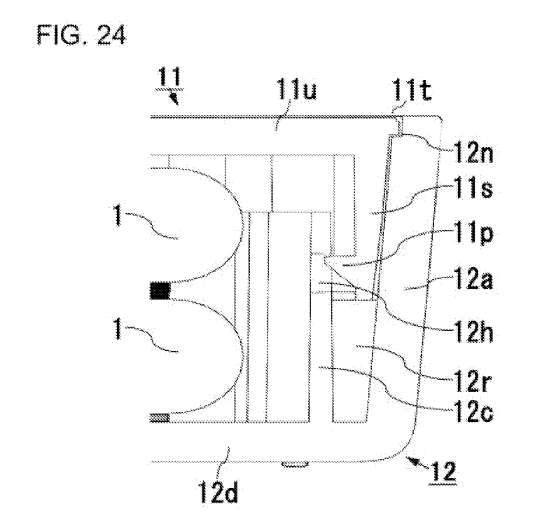

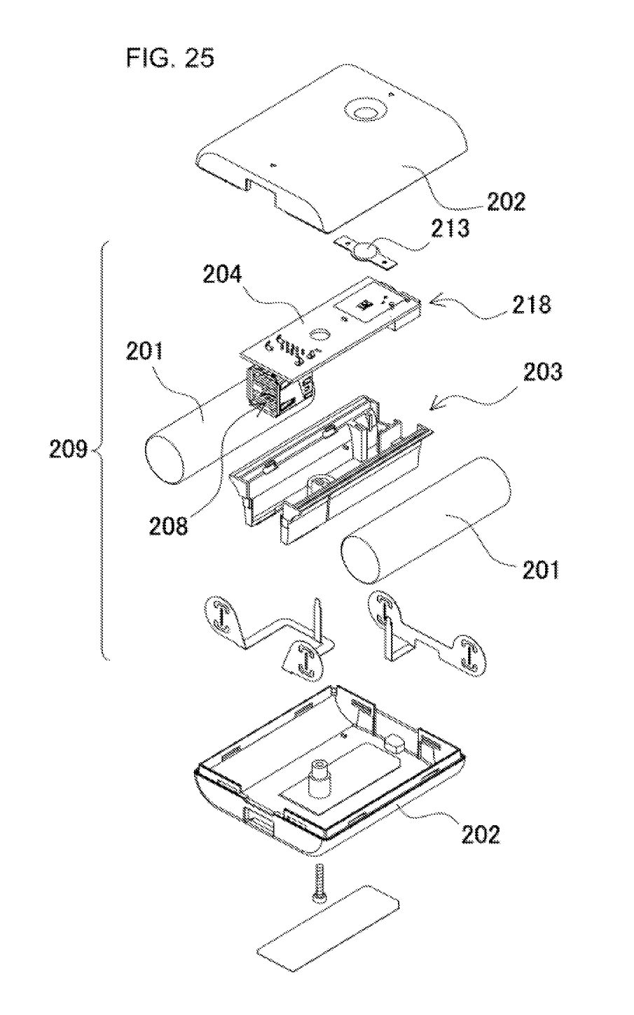

Hereinafter, the portable power supply device 600 related to the embodiment 6 of the present invention is shown in FIG. 20 to FIG. 24. As shown in FIG. 20, the portable power supply device 600 of this embodiment has a low-height box shape, and incorporates the secondary batteries 1, the circuit board 30, and the like. The main body case 10 of the portable power supply device 600 is made of resin, and comprises the first case 11 of the upper side, and the second case 12 of the lower side which is fitted to this.

The first case 11 has a board shape of an upper portion 11u at the upper surface thereof, a flange portion 11t at the peripheral portion of the upper portion 11u, and an inner side wall 11s which is fitted to the second case 12.

The second case 12 has an inner peripheral wall 12c which is disposed at the inner sides of case side walls 12a of the second case 12, in spaced relationship with the case side walls 12a, and the inner side wall 11s is fitted between the case side walls 12a and the inner peripheral wall 12c. The inner peripheral wall 12c has U-shaped walls 12k in a plan view at the inner side of the second case 12, and the top end portions of the U-shaped walls 12k contact the inner side of the first case 11. The second case 12 has a step portion 12n inside the top end of the case side wall 12a which is engaged to the flange portion 11t, and has a board shape of the lower portion 12d at the lower surface thereof.

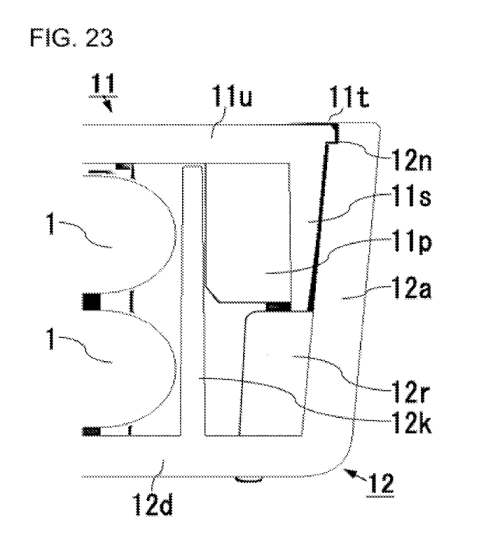

As shown in FIG. 20, FIG. 23, a plurality of openings 12h are provided at the inner peripheral wall 12c of the second case 12, and a plurality of projections 11p are provided at the inner side wall 11s of the first case 11. Then, the inner side wall 11s of the first case 11 is inserted in the space between the case side wall 12a and inner peripheral wall 12c of the second case 12, and the projections 11p of the inner side wall 11s are fitted to the openings 12h of the inner peripheral wall 120, and the first case 11 and the second case 12 can be coupled.

Connecting plates 12r are integrally formed from the lower portion 12d between the case side wall 12a and inner peripheral wall 12c of the second case 12, and then strength is enlarged. The top end portion of the connecting plate 12 contact the lower end portion of the inner side wall 11s of the first case 11, and then strength against the impact from the outside is enlarged.

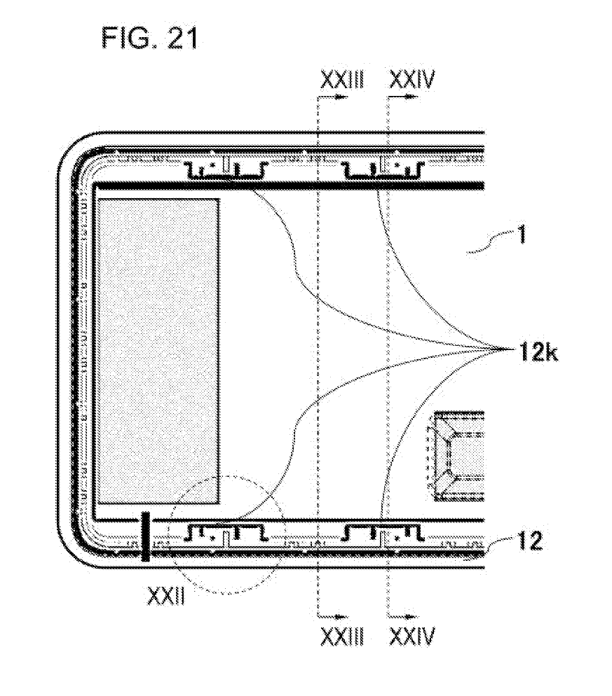

In a plan view of the second case 12, the second case 12 has a separating wall 12w which separates an area storing the secondary batteries 1 and an area storing the circuit board 30. In the area storing the secondary batteries 1, the inner peripheral wall 12c has the U-shaped walls 12k at the four locations so as to project toward the secondary batteries 1 (refer to FIG. 20, FIG. 21). The U-shaped walls 12k position the secondary batteries 1 stored, and also keeps the space between the secondary batteries 1 and the case side walls 12a, and then this space becomes a buffer zone against impact force from the outside, and the impact force is not directly applied to the secondary batteries 1. As the U-shaped wall 12k has perpendicular portions to the case side wall 12a, the second case 12 is strong against impact force from the side.

The top end portions of the U-shaped walls 12k contact the inner side of the first case 11, the side end portions of the U-shaped walls 12k contact the secondary batteries 1, and then the U-shaped walls 12k support the first case 11 and the secondary batteries as support walls.

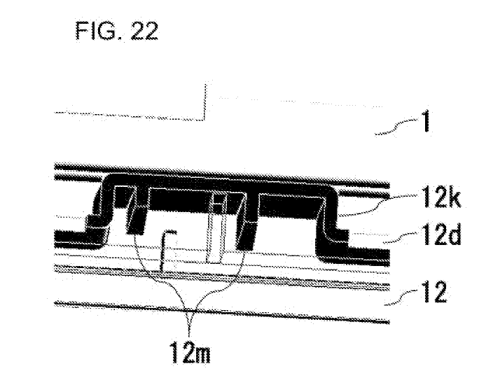

As shown in FIG. 21, FIG. 22, columnar members 12m perpendicular to the case side wall 12a are integrally formed with the U-shaped wall 12k for reinforcing. As shown in FIG. 23, at the location of the U-shaped wall 12k, plate portions 11q are provided at the inner side of the inner side wall 11s of the first case 11 for reinforcing. As the plate portions 11q are engaged with the U-shaped walls 12k, the main body case 10 can be reinforced.

The top end portions of the U-shaped walls 12k contact the inner side of the upper portion 11u of the first case 11. Thus, strength is enlarged against impact in the vertical direction. Here, contacting the U-shaped walls 12k and the first case 11 also includes a case that a clearance between the top end portion of the U-shaped wall and the upper portion 11u of the first case exists at a normal time and they contact at impact applying.

In the area storing the secondary batteries 1, the lower secondary battery 1 is fixed to the lower portion 12d of the second case 12 by the two-faced adhesive tape, and the upper secondary battery 1 is fixed on the lower secondary battery 1 through spacers having adhesive layers on both surfaces thereof. A thick board-shaped cushion having adhesive layers on both surfaces thereof is disposed between the upper secondary battery 1 and the upper portion 11u of the first case 11, and then the secondary batteries 1 are fixed in the main body case 10, and the impact is buffered. Here, the secondary battery 1 is a thick rectangular board shape of a prismatic secondary battery in a plan view.

In the area storing the circuit board 30, the circuit board 30 is electrically connected to lead plates connected to the positive and negative electrodes of the secondary batteries 1, and the secondary batteries 1 are connected in parallel. One electrode is connected to the lead plate through a breaker. Here, the lead plate connected to the one electrode is insulated from the other electrode of the secondary batteries 1 through an insulating board.

An opening 11h is provided at the upper surface of the first case 11, and a button for pushing operation is disposed at the opening 11h. An electric switch is disposed at a location of the circuit board 30 just under the button. The button has an ON/OFF function of starting or stopping of discharging by pushing operation.

Openings are provided at the case side wall 12a in the short side of the second case 12. The outer output terminals 31 of two USB terminals and the power supplied terminal 32 of a micro-USB terminal set on the under surface of the circuit board 30 are provided at the openings. The circuit board 30 includes a charging circuit which uses power inputted from the power supplied terminal 32, and an output conversion circuit which converts output from the charged secondary batteries 1 into a standardized output thereunder. Heat generation parts which easily generate heat, are included in these circuits.

In this embodiment, these heat generation parts contact thermal conductive member of silicone resin, and a heat radiation plate 37 made of aluminum is disposed under the thermal conductive member, and then heat from the heat generation parts is radiated from the heat radiation plate 37. A base projection portion (a projection portion described as an example in FIG. 20) is disposed on the lower portion 12d to keep a space between the heat radiation plate 37 and the lower portion 12d of the second case 12. The heat radiation plate 37 and the projection portion are connected by the two-faced adhesive tape, and an insulating board is disposed between the heat radiation plate 37 and the circuit board 30, and they are insulated.

A submergence judging label is stuck on the lower surface in one of the USB terminals.

The first case 11 and the second case 12 are fixed by plural screws. A rating label of the portable power supply device 600 of this embodiment is stuck on the lower surface of the second case 12.

According to the above configuration, in addition to the case side wall, the holder side wall or the U-shaped wall can support the first case, and then the case side wall has the thickness without generating the sink of a resin when hardening a resin, and strength of the case side wall can be reinforced.

The power supply devices of the embodiments 1 to 6 are portable, but the stationary type can be used. Especially, when the thickness of the main body case is 1 mm to 3 mm, strength against impact from the outside can be enlarged by the configuration of the present disclosure.

### INDUSTRIAL APPLICABILITY

The portable power supply device related to the present invention can be suitably used as an urgent charging device for a mobile phone, a smart phone, a tablet (slate) type PC, a portable music player, or a charging device for the urgent charging device.

REFERENCE MARKS IN THE DRAWINGS

100, 200, 300, 400, 500, 600: portable power supply device
1: secondary battery
10: main body case
11: first case

| | |
|---|---|
| 11b: outer surface extending portion | 11c: inner surface extending |
| | portion |

| | | | |
|---|---|---|---|
| 11s: inner side wall | 11t: flange portion | 11h: opening | 11p: projection |
| 11q: plate portion | 11u: upper portion | | |
| 12: second case | | | |

| | | |
|---|---|---|
| 12a: case side wall | 12b: step-shaped projection | 12c: inner peripheral |
| | | wall |

| | | | |
|---|---|---|---|
| 12d: lower portion | 12h: opening | 12k: U-shaped wall | 12m: columnar |
| | | | member |

| | | |
|---|---|---|
| 12n: step portion | 12r: connecting plate | 12w: separating wall |

13: positioning recess portion
14: terminal window
15, 15B: fitting groove
16: boss
18: projecting strip
19: recess portion
20: battery holder
22: holder side wall
24: holder side boss
26: coil storing portion
30: circuit board
31: outer output terminal
32: power supplied terminal
33: switch portion
34: power switch
36, 36B: terminal cover
37: heat radiation plate
40: power reception coil
41: power reception side mark
42: screw
44: finger catching portion
45: hook portion
46: hook receiving portion
48: display portion
50: charging stand
51: power transmission coil
52: power transmission side mark
60, 60B: covering portion
62, 62B, 62C: cover projecting portion

| | |
|---|---|
| 62b: recess portion | 62c: bending portion |

64: positioning projection
66: cover side switch mark
70: label portion
72: label side switch mark
BD: electric equipment
UC, UC2: USB cable
LC: lightning cable
AC: AC adapter
UA: USB power supply adapter

1. A power supply device connectable to electric equipment for supplying power, comprising:
a main body case divided into a first case and a second case, and having an extending shape in one direction;
a secondary battery incorporated in the main body case; and
a battery holder for holding the secondary battery,
wherein
the second case has a box shape having a bottom portion, and a pair of case side walls in a longitudinal direction,
the battery holder has a pair of holder side walls to hold both sides of the secondary battery,
the holder side walls are formed so as to extend upward along at least a part of the case side walls from the bottom portion of the second case in a state where the battery holder is stored in the second case, and the holder side walls are lower than the case side walls in height,
end edges where side walls of the first case and the side walls of the second case are joined, have step shapes in a vertical sectional view perpendicular to the longitudinal direction,
the second case has a step-shaped projection at an end edge side of the second case, the projection extending toward the first case side at an inner surface side of the main body case,
the first case has an outer surface extending portion at an end edge side of the first case, the outer surface extending portion extending toward the second case side at an outer surface side of the main body case, and an inner surface extending portion at the end edge side of the first case, the inner surface extending portion extending along an inner surface of the second case,
the outer surface extending portion and the inner surface extending portion of the first case sandwich the step-shaped projection of the second case in a state where the first case and the second case are joined,
wherein upper end edges of the holder side walls are in contact with and support a lower end edge of the inner surface extending portion.

2. The power supply device according to claim 1,
wherein a thickness of the main outer case is 1 mm to 3 mm.

3. The power supply device according to claim 1,
wherein the battery holder has a coil storing portion to store a power reception coil for non-contact charging.

4. The power supply device according to claim 1, further comprising a covering portion having flexibility for covering the first case,
wherein the covering portion has a cover projecting portion which projects inward approximately in parallel with and in spaced relationship with a main surface thereof, and the first case has a fitting groove in the side walls for receiving the cover projecting portion.

5. The power supply device according to claim 4,
wherein the first case includes a partially recessed finger catching portion formed in a surface at an approximate center of a short direction perpendicular to the longitudinal direction at the boundary adjacent to the covering portion.

6. The power supply device according to claim 4,
wherein a switch portion is provided at a location decentered from a center in the longitudinal direction.

7. The power supply device according to claim 6,
wherein the covering portion has a cover side switch mark which indicates that the switch portion exists thereunder at a location corresponding to the switch portion in a state where the covering portion covers the first case.

8. The power supply device according to claim 6 further comprising a label portion stuck on an upper surface of the first case so as to cover the switch portion,
wherein the label portion has a label side switch mark which indicates that the switch portion exists thereunder at a location corresponding to the switch portion.

9. The power supply device according to claim 8,
wherein the label side switch mark of the label portion is formed by embossing.

10. The power supply device according to claim 4,
wherein the covering portion has a positioning projection on an inner surface of the cover projecting portion, and
the first case has a positioning recess portion formed to engage with the positioning projection at a location corresponding to the positioning projection,
the covering portion is not symmetrical by the positioning projection, and it prevents the covering portion from being set in the reverse posture to the first case.

11. (canceled)

12. A power supply device connectable to electric equipment for supplying power, comprising:
a main body case divided into a first case and a second case, and having an extending shape in one direction; and
a secondary battery incorporated in the main body case,
wherein
the second case has a box shape having a bottom portion, a pair of case side walls in a longitudinal direction, and an inner peripheral wall disposed inside the case side walls and along the case side walls,
the inner peripheral wall has a pair of support walls to hold both sides of the secondary battery, the support walls are formed so as to extend upward along at least a part of the case side walls from the bottom portion of the second case, and the support walls are lower than the case side walls in height,
the upper end edges of the support walls are in contact with and support the first case, and
the first case has inner side walls which are fitted between the case side walls and the inner peripheral wall.

13. The power supply device according to claim 12,
wherein each of the support walls is a U-shaped wall which comprises a portion parallel to the case side walls, and portions orthogonal to the case side walls.

14. The power supply device according to claim 12,
further comprising a circuit board disposed adjacent to the secondary battery in a extending direction of the secondary battery, and a heat radiation plate which is thermally coupled to heat generation parts of the circuit board and is disposed under the circuit board,
wherein there is a space between the second case and the heat radiation plate.

15. The power supply device according to claim 1, wherein the secondary battery is a prismatic secondary battery.

16. The power supply device according to claim 12, wherein the secondary battery is a prismatic secondary battery.
